(19) United States
(12) Patent Application Publication
(10) Pub. No.: US 2019/0048257 A1
(43) Pub. Date: Feb. 14, 2019

(54) METHOD FOR PRODUCING ENCAPSULATED QUANTUM DOTS

(71) Applicants: Dow Global Technologies LLC, Midland, MI (US); Rohm and Haas Electronic Materials LLC, Marlborough, MA (US)

(72) Inventors: Jake Joo, Somerville, MA (US); Kathleen M. O'Connell, Cumberland, RI (US); Liang Chen, Midland, MI (US); Daniel L. Dermody, Midland, MI (US); Zhifeng Bai, Midland, MI (US); James C. Taylor, Grafton, MA (US)

(21) Appl. No.: 16/078,815

(22) PCT Filed: Apr. 3, 2017
(86) PCT No.: PCT/US2017/025734

§ 371 Date: Aug. 22, 2018

Related U.S. Application Data
(60) Provisional application No. 62/321,279, filed on Apr. 12, 2016.

(51) Int. Cl. C09K 11/02

(52) U.S. Cl. CPC C09K 11/025; B82Y 20/00

(57) ABSTRACT

A method for encapsulating quantum dots. The method comprises steps of: (a) mixing quantum dots with a polymer having a molecular weight from 1,000 to 200,000 and a solubility parameter from 14 to 18.75 (J/cm³)^{1/2} and a solvent to form a mixture; and (b) spray drying the mixture to produce an encapsulated quantum dot powder.

### FIELD OF THE INVENTION

The present invention relates to a method for producing encapsulated quantum dots.

### BACKGROUND OF THE INVENTION

Semiconductor quantum dots (QD) provide optical absorption and emission (photoluminescence PL or electroluminescence EL) behaviors that are significantly different from those of bulk materials. As the particle size decreases, effective energy bandgap (Eg), or available energy levels, increases and creates a blue shifted PL spectrum. This spectrum tunability by the particle size dependent quantum confinement effect within the same material is a critical advantage over conventional bulk semiconductors. Because of their unique optical properties, QD have been of great interest in many display and lighting applications. Most QD have inorganic shells with a larger bandgap material to confine electron and hole pairs within the core region and prevent any surface charge states. The outer shells are then capped by organic ligands to reduce trap states of the shell that can lead to reduced quantum yield (QY). Organic ligands help QD to disperse in organic/aqueous solvents. Typical organic ligands surrounding QD have relatively long alkyl chains which provide high solubility in non-polar solvents or monomers. Unfortunately, QD are very susceptible to photo-oxidation during light absorption/conversion process. Also, moisture can have similar impacts when ligands are not compatible with solvents or monomers. QD typically are encapsulated in a polymer matrix to protect them from adverse effects of water and oxygen. For example, U.S. Pat. No. 8,859,442 discloses encapsulated quantum dots in polymer matrices. However, this reference does not disclose the method described herein.

### SUMMARY OF THE INVENTION

The present invention provides a method for encapsulating quantum dots. The method comprises steps of: (a) mixing quantum dots with a polymer having a molecular weight from 1,000 to 200,000 and a solubility parameter from 14 to 18.75 (J/cm³)^{1/2}, and a solvent to form a mixture; (b) spray drying the mixture to produce an encapsulated quantum dot powder with a particle size from 1-10 micron.

### DETAILED DESCRIPTION OF THE INVENTION

Percentages are weight percentages (wt %) and temperatures are in ° C., unless specified otherwise. Operations were performed at room temperature (20-25° C.), unless specified otherwise. Boiling points are measured at atmospheric pressure (ca. 101 kPa). The term “(meth)acrylate” means acrylate or methacrylate. Quantum dots are well known in the art, see, e.g., US2012/0113672. Molecular weight is measured in Daltons and is the sum of the atomic weights for a monomeric compound and the weight-average molecular weight (Mw) for mixtures, e.g., oligomeric or polymeric compounds.

Preferably, the polymer has an acid value from 0 to 500 mg KOH/g; preferably no greater than 350, preferably no greater than 200. Preferably, the polymer has a molecular weight of at least 2,000, preferably at least 3,000; preferably no more than 200,000, preferably no more than 175,000, preferably no more than 150,000. Preferably, the polymer has a solubility parameter of at least 15 (J/cm³)^{1/2}; preferably at least 15.5; preferably no greater than 18.5, preferably no greater than 18.25. The polymer preferably has a glass transition temperature (T_{g}) or melting temperature of at least 50° C., preferably at least 60° C.; preferably no greater than 200° C., preferably no greater than 150° C.

Preferably, the polymer comprises a compound comprising at least one readily polymerizable vinyl group; preferably the compound has a molecular weight of at least 28, preferably at least 72, preferably at least 86; preferably no more than 500, preferably no more than 400. Preferably, the compound comprising at least one readily polymerizable vinyl group has one or two readily polymerizable vinyl groups, preferably one; even when this compound contains only one readily polymerizable vinyl group, additional monomer(s) may be present which have higher functionality. When the compound comprising at least one readily polymerizable vinyl group is an oligomer the number of vinyl groups is the number average for the distribution. Preferably, the readily polymerizable vinyl groups are (meth)acrylate ester groups (CH₂═C(R)C(O)O—, where R is H or CH₃; also known as (meth)acryloyloxy). Preferably, the compound comprising at least one readily polymerizable vinyl group has no atoms other than carbon, hydrogen, oxygen and nitrogen atoms; preferably carbon, hydrogen and oxygen (this does not exclude trace levels from impurities);

Preferably, the solvent has a solubility parameter from 14.5 to 18.5 (J/cm³)^{1/2}; preferably at least 14.75, preferably at least 15.0; preferably no greater than 18.25, preferably no greater than 18.0. Preferably, the solvent is a C₆-C₁₂ hydrocarbon or ether solvent, preferably a C₆-C₁₀ hydrocarbon or ether solvent, preferably a C₆-C₁₀ hydrocarbon solvent. Preferably, the solvent is aromatic, i.e., it contains at least one aromatic ring. If more than one solvent is used, the solubility parameter of the solvent mixture is the weight average of the solubility parameters of the individual solvents.

Preferred polymers are high-T_{g}, amorphous polymers not containing any acid functionality. Especially preferred polymers include olefin-based (co)polymers, alkyl styrene based (co)polymers and (meth)acrylate ester based (co)polymers. Especially preferred compounds comprising at least one readily polymerizable vinyl group include isobornyl (meth)acrylate, C₂-C₁₈ alkyl (meth)acrylates (e.g., isobutyl (meth)acrylate, 3,5,5-trimethylhexyl acrylate, dodecyl acrylate, decyl acrylate, tridecyl acrylate and isodecyl acrylate), L-menthyl acrylate, tricyclo[5.2.1.0^{2,6}]decylmethyl acrylate, C₁-C₆ alkylstyrenes, 3,3,5-trimethylcyclohexyl methacrylate and 3,3,5-trimethylcyclohexyl methacrylate.

Preferably, the material which is spray dried, i.e., the mixture of quantum dots and solvent and the polymer, comprises from 0.001 to 2.4 wt % quantum dots; preferably at least 0.0025 wt %, preferably at least 0.005 wt %; preferably no more than 1.6 wt %, preferably no more than 0.8 wt %. Preferably, the material which is spray dried comprises from 1 to 30 wt % of the first polymer; preferably at least 3 wt %, preferably at least 5 wt %; preferably no more than 25 wt %, preferably no more than 20 wt %. Preferably, the material which is spray dried comprises from 50 to 99 wt % solvent; preferably at least 60 wt %, preferably at least 70 wt %; preferably no more than 97 wt %, preferably no more than 95 wt %.

Preferably, the spray drying is performed under inert atmosphere with an outlet temperature of <100 C, preferably <80° C.; preferably <60° C. Preferably, the spray dryer is equipped with a two fluid atomizer. Preferably, the dry powder has 0.1-10 micron average particle size, preferably at least 0.5 micron, preferably at least 1 micron; preferably no more than 8 micron, preferably no more than 6 micron.

The spray dried powder of encapsulated QDs is dispersed in liquid monomers with scattering agent and photo initiators and cured into solid films. The resin is physically stable and can be tested more easily.

### EXAMPLES

### Abbreviations Used in Examples

PiBOMA is polyisobornyl methacrylate (Mw=100 kg/mol, T_{g}=110° C.) from Scientific Polymer Products
PTBS: Poly(p-tert-butylstyrene) (T_{g}=132° C.) from Scientific Polymer Products
COC 5013 is ethylene-norbornene copolymer (Mw=80.5 kg/mol, T_{g}=140° C.) from TOPAS
SMA EF-60 is styrene-maleic anhydride copolymer (Mw=11.5 kg/mol, acid value=156 KOH/g) from Cray Valley
HEA is 2-hydroxyethyl acrylate from Sigma-Aldrich, Inc.
SR494 is C{CH₂OCH₂CH₂OC(O)CH═CH₂}₄ from Sartomer, Inc.
I-819 is an IRGACURE photoactive polymerization initiator from Ciba-Geigy Corp.
FINEX 30S LP2 is ultrafine Zinc Oxide from Sakai Chemical Industry Co.

### Preparation of Encapsulated QDs by Spray Drying

A typical spray drying condition is described below unless specified. A fountain two-fluid nozzle atomizer was equipped on a MOBILE MINOR spray dryer (GEA Process Engineering Inc.). The polymer/QDs solution was fed into spray dryer using a peristaltic pump (MASTERFLEX L/S). Inlet temp 80° C. and outlet temp 55° C. Liquid feed rate=10 mL/min (setting) and N₂ flow rate to nozzle atomizer=1 bar 60% flow. The spray drying process produces a free-flowing QD polymer powder with well-controlled particle size of ˜5 micron where QDs is uniformly dispersed in the polymer matrix without aggregation

### PLQY Measurement

PLQY was measured using an absolute PL quantum yield spectrometer (QUANTAURUS (C11347-01), Hamamatsu, Japan). Integrating sphere allows ˜99% reflection from 350˜1600 nm. Both incident and emitted photons have to undergo multiple reflections in order to reach detector (this helps eliminate optical anisotropy in the quantum yield measurement). Excitation wavelength is set at 450 nm and wavelength for PL is between 460 and 950 nm. Solution samples are placed at the center (transmission) of the integration sphere; film samples are placed at the bottom. Direct measurement of absolute PLQY is the ratio of # of photons emitted to # of photons absorbed

### Preparation of QD Resin Films

The film formulation was prepared in a oxygen-free environment (e.g. in a glovebox)

1. Monomers were degassed under vacuum for 1 hour
2. A solution of 50 wt % FINEX 30S LP2 in above monomers was prepared by using a speed mixer (FlackTek Inc, Landrum, S.C.))
3. A solution of 1.75 wt % I-819 in above monomers was prepared by stirring the mixture at room temperature
4. Into the QD sample the I-819/monomers was introduced
6. FINEX 30S LP2/monomers solution was mixed into above solution by using speed mixer
7. QDs film of ˜100 um was prepared by curing the monomers under UV (UVA, ˜400 mJ/cm²) sandwiched by two i-components barrier films for QY testing

### Example 1

Solution PLQY of Polymer with Green QDs in Toluene

| | | QY | | Emission | FWHM |
|---|---|---|---|---|---|
| | Solvent | (%) | Absorbance | peak (nm) | (nm) |
| 1 | Toluene | 72.4 | 0.106 | 535.4 | 43.1 |
| 2 | 10 wt % PiBOMA in | 68.5 | 0.089 | 535.4 | 43.0 |
| | toluene | | | | |
| 3 | 10 wt % ethylene- | 72.5 | 0.085 | 534.2 | 44.0 |
| | norbornene copolymer in | | | | |
| | toluene | | | | |
| 4 | 10 wt % PTBS in toluene | 62.8 | 0.090 | 536.6 | 43.1 |
| 5 | 10 wt % SMA EF-60 in | 58.9 | 0.116 | 539.6 | 42.9 |
| | toluene | | | | |

* take 0.2 g of each solution (0.77 mg QD/mL) to a 1 mL vial and then measure PL QY,

PWL, FWHM at 450 nm excitation using Hamamatsu absolute PL QY equipment

### Example 2: CF-QD®s in HEA/CN104 Monomers

| | Sample 1 | Sample 2 | Sample 3 |
|---|---|---|---|
| 2-Hydroxy Ethyl Acrylate (HEA) | 97.5 wt % | 90 wt % | 97.5 wt % |
| PTBS/QD Powder 1 (8.75 OD/g) | | 10 wt % | |
| PTBS/QD Powder 2 (43.75 OD/g) | | | 2.5 wt % |
| QD in IBOA (35 OD/g) | 2.5 wt % | | |

Red QDs in toluene: Manc11_Z A1 (151.2 OD/mL (450 nm excitation)
PTBS: M_{w}=50-100 kg/mol, T_{g}=144° C.
QD powder specification

PTBS powder 1: 0.5 wt % red QDs (8.75 OD/g)

PtBSt powder 2: 2.5 wt % red QDs (43.75 OD/g)

### Control Sample QD in IBOA

2.098 g of IBOA+QD in toluene 0.5 mL (0.5×151.2/2.098=35 OD/g)

Sample 1

| Time (hrs) | Absorption | PLQY | PWL | FWHM |
|---|---|---|---|---|
| 0 | 0.062 | 54 | 653.27 | 62.59 |
| 24 | 0.060 | 27 | 466.36 | 48.33 |

Sample 2

| Time (hrs) | Absorption | PLQY | PWL | FWHM |
|---|---|---|---|---|
| 0 | 0.096 | 50 | 639.15 | 57.51 |
| 24 | 0.121 | 52.9 | 639.89 | 57.24 |

Sample 3

| Time (hrs) | Absorption | PLQY | PWL | FWHM |
|---|---|---|---|---|
| 0 | 0.357 | 47.6 | 647.32 | 60.71 |
| 24 | 0.398 | 51.1 | 645.1 | 56.64 |

### Example 3—CF-QD® in PIBOMA in HEA/SR-494 Monomers

### PiBOMA/QD Encapsulated Powder: 2 wt % Green QDs

### Encapsulated QD Resin Films:

| | | | | | Emission | |
|---|---|---|---|---|---|---|
| | | | | | peak | FWHM |
| | Solvent/monomers | QDs | QY (%) | Absorbance | (nm) | (nm) |
| A | HEA/SR494 (1:1) | 0.75 g PiBOMA/QD | 57.4 | 0.1031 | 542.4 | 43.6 |
| | (2.25 g)* | powder | | | | |
| | Cured resin film (3 OD/g, | | 45.3 | 0.1366 | 538.7 | 45.1 |
| | thickness = 103 μm) | | | | | |
| B | HEA/SR494 (1:1) | 0.17 g QDs in | 52.3 | 0.0760 | 551.1 | 41.9 |
| (comp) | (2.83 g)* | IBOA (0.085 wt | | | | |
| | | %) | | | | |

| | | | | |
|---|---|---|---|---|
| Cured resin film (3 OD/g, | 36.8 | 0.1344 | 549.4 | 43.9 |
| thickness = 108 μm) | | | | |

*Both formulations contain 1.5 wt % I-819 and 2.125 wt % Finex 30S LP2

### Structure of SR494

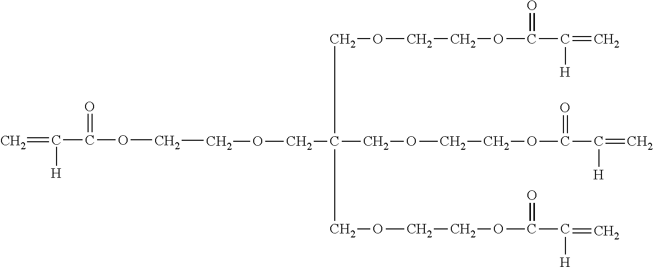 [SMILES: C=CC(=O)OCCOCC(COCCOC(=O)C=C)(COCCOC(=O)C=C)COCCOC(=O)C=C]

### Encapsulated QDs Show Better QY Retention in Polar Matrix and Lower Red Shift of Emission Peak

### Age QD Resin Films at 60° C./95% RH

| | | | | |
|---|---|---|---|---|
| | | | Emission | |
| | | | peak | FWHM |
| QD Resin Film | QY (%) | Absorbance | (nm) | (nm) |

Film A, 3 OD/g

| | | | | | |
|---|---|---|---|---|---|
| 0 h | thickness = 103 μm | 45.3 | 0.137 | 538.7 | 45.1 |
| 96 h | 92 μm | 43.8 | 0.125 | 537.1 | 45.5 |
| 216 h | 132 μm | 37.1 | 0.120 | 536.9 | 46.0 |

Film B (control), 3 OD/g

| | | | | | |
|---|---|---|---|---|---|
| 0 h | Thickness = 108 μm | 36.8 | 0.134 | 549.4 | 43.9 |
| 96 h | 103 μm | 30.9 | 0.104 | 546.2 | 42.4 |
| 216 h | 142 μm | 22.2 | 0.105 | 547.5 | 42.1 |

Film containing encapsulated QDs shows better retention of QY under the aging condition.

1. A method for encapsulating quantum dots; said method comprising steps of:
(a) mixing quantum dots with a polymer having a molecular weight from 1,000 to 200,000 and a solubility parameter from 14 to 18.75 (J/cm³)^{1/2} and a solvent to form a mixture; and
(b) spray drying the mixture to produce an encapsulated quantum dot powder.

2. The method of claim 1 in which the polymer has a T_{g} of 60 to 200° C.

3. The method of claim 2 in which the polymer comprises polymerized units of a compound comprising one or two readily polymerizable vinyl groups and a molecular weight from 44 to 400.

4. The method of claim 3 in which the solvent has a solubility parameter from 14.5 to 18.5 (J/cm³)^{1/2}.

5. The method of claim 4 in which the spray drying is performed in a spray dryer equipped with a two fluid nozzle atomizer.

6. The method of claim 5 in which the polymer has a solubility parameter from 14.5 to 18.5 (J/cm³)^{1/2}.

7. The method of claim 6 in which the mixture of quantum dots and solvent and polymer comprises from 0.001 to 2.4 wt % quantum dots.

8. The method of claim 7 in which the compound comprising at least one readily polymerizable vinyl group contains no atoms other than carbon, hydrogen and oxygen atoms.
